(19) United States
(12) Patent Application Publication
(10) Pub. No.: US 2011/0300381 A1
(43) Pub. Date: Dec. 8, 2011

(54) Novel stable aqueous dispersions of high performance thermoplastic polymer nanoparticles and their uses as film generating agents

(75) Inventors: Jean-Michel BERGERAT, FONSORBES (FR); Isabelle GIRAUD, PORTET-SUR-GARONNE (FR); Eric DANTRAS, TOULOUSE (FR); Emile PEREZ, COLOMIERS (FR); Colette LACABANNE, TOULOUSE (FR)

(73) Assignees: AIRBUS OPERATIONS S.A.S., Toulouse (FR); CENTRE NATIONAL DE LA RECHERCHE SCIENTIFIQUE (C.N.R.S.), Paris (FR)

(21) Appl. No.: 13/153,674

(22) Filed: Jun. 6, 2011

(30) Foreign Application Priority Data
Jun. 7, 2010 (FR) 10 54437

(51) Int. Cl. B05D 3/02; C08L 79/08; D02G 3/00; C08K 5/3415; C08L 61/16; B82Y 40/00; B82Y 30/00

(52) U.S. Cl. 428/378; 427/385.5; 427/389.9; 524/104; 524/538; 524/592; 524/608; 977/773; 977/890

(57) ABSTRACT

Novel aqueous dispersions of thermoplastic polymers suitable for generation of films, notably for the sizing of fibers for facilitating their handling and for making composite materials.

The present invention relates to the field of polymers suitable for generating films, notably the sizing of fibers for facilitating handling thereof and for making composite materials.

Presently, most composite materials used in high performance applications are based on carbon fibers and thermosetting matrices such as polyepoxy resins. However, these thermosetting matrices suffer from low chemical resistance and low mechanical impact resistance causing complexity of formulation which complicates their application. Further, these composite materials are not recyclable because of their three-dimensional chain architecture.

These drawbacks therefore explain the potential benefit of thermoplastic matrices which would further satisfy the criteria for respecting the environment. Thermostable thermoplastic matrices may be used in high-tech activity fields such as aeronautics and the space industry.

Regardless of the nature of the matrix, the interface of the matrix with the carbon fiber remains a crucial point. For this, the fiber is covered with a thin layer called size. This size is generally of an oligomeric or polymeric nature which may be adapted depending on the matrix used. It has the role of facilitating handling of the fibers during application but especially of promoting interactions between the fiber and the matrix. Given that the majority of high performance composites presently used are based on thermosetting matrices, most of the sizings consist of epoxy resin. Consequently, there does not exist any sizing adapted to thermoplastic matrices, notably to thermostable thermoplastic matrices, the sizing of which should resist to high application temperatures, sometimes above 300° C.

From a practical point of view, sizing is ideally accomplished by soaking or by spraying on the fibers, from a polymer in a solution or dispersion in a solvent.

For health, safety reasons and also in order to preserve the environment, it is desirable to use water as a solvent. However, high performance thermoplastic polymers are generally insoluble in water and their polymerization method is often incompatible with the latter. It is therefore desirable to make available stable aqueous dispersions of thermostable thermoplastic polymers.

Obtaining stable aqueous dispersions of nanoparticles of polymers may be achieved in different ways:
a) by polymerization in an aqueous emulsion or micro-emulsion, leading to the formation of a latex,
b) by emulsion/evaporation of the solvent,
c) by solvent diffusion or extraction,
d) by complex coacervation.

Methods b)-d) are widely used, notably in the agrifood and pharmaceutical industry for encapsulating active ingredients, notably for controlling the release rate and for avoiding degradation of the active ingredient.

However, no stable aqueous dispersion of high performance thermoplastic polymers having physico-chemical characteristics notably allowing sizing has been developed.

The object of the invention is the elaboration of stable and long term storage aqueous dispersions of nanoparticles of polymers having physical properties compatible with thermoplastic sizing.

According to a first object, the present invention therefore relates to a stable aqueous dispersion of nanoparticles of a high performance thermoplastic polymer or of mixtures of high performance thermoplastic polymers.

The dispersions according to the invention are stable for at least six months under normal storage conditions at room temperature.

In an advantageous aspect of the invention, the polymers to be dispersed will be selected according to their physical properties (temperature resistance, solubility) compatible with thermoplastic sizing, as well as with the previously selected dispersion techniques.

Said thermoplastic polymers suitable for the invention are selected from the family of polyetherimides and polyaryletherketones as well as from their mixtures such as for example, polyetherimide (PEI), polyetherketoneketone (PEKK).

The polyetherimide (PEI) may be illustrated by the following formula:

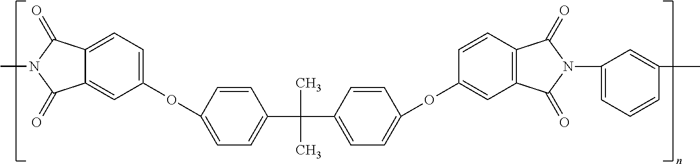

Polyetherketoneketone (PEKK) may be illustrated by the following formula:

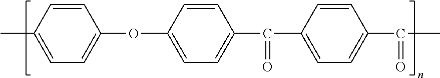

In the sense of the present invention, by polymers are meant compounds having a polymerization degree comprised between 2 and 100.

According to the present invention, the PEI preferentially has an average polymerization degree comprised between 10 and 50, notably about 20 i.e., an average molecular mass of 12,000 g/mol and PEKK preferentially has an average polymerization degree comprised between 1 and 10, advantageously about 3, i.e. an average molecular mass of 1,000 g/mol.

The stable aqueous dispersions according to the invention essentially consist of nanoparticles of said polymer(s) having an average diameter comprised between 10 and 1000 nm, preferentially between 50 et 150 nm.

The mass percentage of said polymer(s) in the dispersions according to the invention is generally comprised between 0.01 et 0.1%, preferentially between 0.03 et 0.06%. These ranges of sizes and concentrations are advantageous, notably for a sizing deposit.

The dispersions according to the invention may further comprise one or more emulsifying agents and/or dispersants. These agents may notably be selected from the family of surfactants and/or water-soluble or amphiphilic polymers.

Generally, the mass percentage of emulsifier and/or dispersing agents is comprised between 0.01 and 20%, preferentially between 0.01 and 5%, and advantageously about 0.5%.

Among the surfactants, mention may be made of non-ionic, cationic, anionic, zwitterionic, hydrogenated or fluorinated amphiphilic molecules, such as for example sodium cholate, sodium deoxycholate, sodium glycocholate, sodium taurocholate, sodium taurodeoxycholate, lecithins, phospholipids, Tween 20, Tween 40, Tween 60, Tween 80, Span 20, Span 40, Span 60, Span 80, sodium dioctylsulfosuccinate, sodium dodecylsulfate, ammonium salts with long chains such as hexadecyltrimethylammonium bromide as well as all the combinations of these molecules.

In an advantageous aspect of the invention, the surfactant is selected from sodium dodecylsulfate and/or sodium dioctylsulfosuccinate.

The dispersant polymers suitable for the application of the present invention may be selected from macromolecules of natural or synthetic origin, homopolymers or copolymers, charged homopolymers or charged copolymers, amphiphilic homopolymers or amphiphilic copolymers, hyper-branched polymers or copolymers, dendrimers, polysaccharides, as well as all the combinations of these macromolecules, emulsifiers such as gelatin, as well as all the combinations of these polymers.

According to the invention, the dispersions are prepared from an emulsion or from an emulsion/dispersion of oil in water by an evaporation method or by diffusion in water of a polymer solution or by dispersion in the oil phase.

According to another object, the present invention therefore also relates to the method for preparing a dispersion according to the invention, said method comprising the transfer of said polymer(s) of a solution or dispersion in an organic solvent or a mixture of organic solvents to an aqueous phase, such that:
said polymer(s) is(are) soluble or dispersible in said organic solvent(s); and
said organic solvent(s) is(are) miscible or non-miscible with water.

In the sense of the present invention, by volatile solvent non-miscible with water under normal pressure and temperature conditions, are meant compounds advantageously formed by chloroform, methylene chloride, dichloromethane, dichloroethane, aliphatic hydrocarbons, halogenated aliphatic hydrocarbons, aromatic hydrocarbons, cyclohexane, halogenated aromatic hydrocarbons, ethers, ethyl acetate, ethyl formate and their mixtures. More advantageously, the solvent is chloroform.

In the sense of the present invention, by solvent miscible with water are meant compounds advantageously selected from the group comprising methanol, ethanol, isopropanol, dimethylformamide, dimethylsulfoxide, acetonitrile, acetone, dioxane and N-methyl-2-pyrrolidone. More advantageously, the solvent is N-methyl-2-pyrrolidone.

The mass percentage of polymer(s) in said organic solvent(s) is generally comprised between 0.1 and 10%, preferentially comprised between 1 and 5%, advantageously about 3%.

The method according to the invention generally comprises the following steps:
a) dissolution or dispersion of said polymer(s) in said organic solvent(s);
b) mixing of the solution or dispersion obtained in step (a) with the aqueous solution optionally comprising one or more emulsifiers and/or dispersants;
c) evaporation or diffusion of said organic solvent(s).

The volume fraction of solvent(s) in the solvent(s)+water mixture (step (a)) is generally comprised between 0.05 and 0.5, advantageously about 0.1.

According to whether said polymer(s) is(are) soluble or dispersible in said organic solvent(s) and whether said organic solvent(s) is(are) miscible or non-miscible with water, four possible embodiments (numbered from P1 to P4) for applying the method according to the invention are therefore distinguished:

P1:

When said polymer(s) is(are) soluble in said organic solvent(s) and said organic solvent(s) is(are) volatile, non-miscible with water, the dispersion according to the invention may be made by emulsion and evaporation.

Thus, according to this embodiment the method according to the invention comprises the evaporation step from an emulsion of said soluble polymer(s) in said volatile organic solvent(s) non-miscible with water.

More specifically, the method P1 comprises the following successive steps:
a) dissolution of the polymer or of the mixture of polymers in a volatile organic solvent, from 0.1 to 10% by mass, advantageously 3% by mass,
b) an amount corresponding to a final volume percentage of 5-50% advantageously 10%, of the mixture obtained following step a) is poured into water, if need be, comprising an emulsifier or dispersant such as a surfactant or a polymer, advantageously a surfactant. This agent is generally present in a mass concentration from 0.01 to 20%, advantageously 0.5%. The mixture is then emulsified with strong mechanical stirring or with ultrasound, advantageously with ultrasound.
c) The emulsion obtained following step b) is mechanically stirred at atmospheric pressure or in vacuo and at a temperature which may range from 5° C. up to the boiling temperature of the solvent at the selected pressure, more advantageously at room temperature and under atmospheric pressure. The emulsion is then mechanically stirred until total evaporation of the solvent,
d) obtaining the final stable dispersion comprising particles with a size comprised between and 10 and 150 nm at a mass percentage from 0.01 to 0.1%, advantageously 0.03%.
Advantageously, the method P1 is used for obtaining stable dispersions of PEI, preferentially by using chloroform as a volatile solvent non-miscible with water.

P2:

When said polymer(s) is(are) soluble in said organic solvent(s) and said organic solvent(s) is(are) miscible with water, the dispersion according to the invention may be made by diffusion.

Thus, according to this embodiment, the method according to the invention comprises the step for diffusing a solution of said polymer(s) in said organic solvent(s) miscible with water.

More specifically, the method P2 comprises the following successive steps:
a) dissolution of the polymer or of the mixture of polymers in an organic solvent miscible with water, from 0.1 to 5% by mass, advantageously 3% by mass.
b) an amount corresponding to a final volume percentage of 0.1 to 50%, advantageously 10%, of the mixture obtained following step a) is poured or injected into water, if need be, comprising an emulsifier or dispersant such as a surfactant or a polymer, advantageously a surfactant. This agent is generally present at a mass concentration of 0.01 to 20% advantageously 0.5%.
c) The dispersion obtained following step b) is mechanically stirred until total diffusion of the solvent, and advantageously at room temperature and under atmospheric pressure.
d) obtaining the final stable dispersion comprising particles with a size comprised between 10 and 200 nm at a mass percentage from 0.01 to 0.1%, advantageously 0.03%.

Advantageously, the method P2 is used for obtaining stable dispersions of PEI, by preferentially using N-methyl-2-pyrrolidone as a solvent miscible with water.

P3:

When said polymer(s) is(are) dispersible in said organic solvent(s) and said organic solvent(s) is(are) volatile, non-miscible with water, the dispersion according to the invention may be made by emulsion/dispersion and evaporation.

Thus, according to this embodiment, the method according to the invention comprises the evaporation step from an oil-in-water emulsion/dispersion of said polymer(s) dispersible in said volatile organic solvent(s) non-miscible with water.

More specifically, the method P3 comprises the following successive steps:
a) dispersion of the polymer or of the mixture of polymers in a volatile organic solvent, from 0.1 to 10% by mass, advantageously 3% by mass,
b) an amount corresponding to a final volume percentage of 5-50%, advantageously 10%, of the mixture obtained following step a) is poured in water, if need be, comprising an emulsifier or dispersant such as a surfactant or a polymer, advantageously a surfactant. This agent is generally present in a mass concentration from 0.01 to 20%, advantageously 0.5%. The mixture is then emulsified/dispersed under strong mechanical stirring or with ultrasound, advantageously with ultrasound,
c) the emulsion/dispersion obtained following step b) is mechanically stirred at atmospheric pressure or in vacuo and at a temperature which may range from 5° C. up to the boiling temperature of the solvent at the selected pressure, more advantageously at room temperature and under atmospheric pressure. The emulsion/dispersion is then mechanically stirred until total evaporation of the solvent,
d) obtaining the final stable dispersion comprising particles with a size comprised between 10 and 250 nm at a mass percentage from 0.01 to 0.1%, advantageously 0.03%.

Advantageously, the method P3 is used for obtaining stable PEKK dispersions, by preferentially using chloroform as a volatile solvent non miscible with water.

P4:

When said polymer(s) is(are) dispersible in said organic solvent(s) and said organic solvent(s) is(are) miscible with water, the dispersion according to the invention may be achieved by diffusion.

Thus, according to this embodiment, the method according to the invention comprises the diffusion step for a dispersion of said polymer(s) in said organic solvent(s) miscible with water.

More specifically, the method P4 comprises the following successive steps:
a) dispersion of the polymer or the mixture of polymers in an organic solvent miscible with water, from 0.1 to 10% by mass, advantageously 5% by mass,
b) an amount corresponding to a final volume percentage of 0.1-10%, advantageously 5%, of the mixture obtained following step a) is poured or injected into water, if need be, comprising an emulsifier or dispersant such as a surfactant or a polymer, advantageously a surfactant. This agent is generally present at a mass concentration from 0.01 to 20% advantageously 0.5%,
c) The dispersion obtained following step b) is mechanically stirred until total diffusion of the solvent, and advantageously at room temperature and under atmospheric pressure,
d) obtaining the final stable dispersion comprising particles with a size comprised between 10 and 250 nm at a mass percentage from 0.01 to 0.1%, advantageously 0.03%.

Advantageously, the method P4 is used for obtaining stable PEKK dispersions, while preferentially using N-methyl-2-pyrrolidone as a solvent miscible with water.

The thereby obtained stable aqueous dispersions may be used for forming coating films, preferentially for sizing of fibers or carbon nanotubes or of other morphologies based on carbon, as well as of aromatic polyamides, in order to elaborate thermoplastic composite materials.

Thus, according to another object, the present invention relates to a method for generating a film on a support comprising:
deposition of a dispersion according to the invention on said support; and
evaporation of water.

Said support may notably be selected from carbon fibers or nanotubes, fibers of aromatic polyamides, aramide fibers.

The present invention also aims at sized fibers which may be obtained by the method according to the invention.

According to another object, the present invention also relates to sizing comprising nanoparticles of a high performance thermoplastic polymer or of mixtures of high performance thermoplastic polymers as defined hereinbefore.

The particular sizing made by the deposited film of nanoparticles allows improvement in the application of the fibers and in the adhesion between fibers and matrix, particularly with polyaryletherketones (PAEK) matrices such as polyetheretherketone (PEEK) or polyetherketones (PEKs).

According to another object, the present invention also relates to a composite material comprising:
sized fibers according to the invention or fibers covered with sizing according to the invention, and
a thermoplastic polymeric matrix.

Said thermoplastic matrix is notably a polyaryletherketone (PAEK) matrix such as polyetheretherketone (PEEK) or polyetherketones (PEKs).

The following examples and figures to which reference is made, are given as an illustration and not as a limitation of the present invention.

### FIGURES

FIG. 1 illustrates a suspension of PEI particles in transmission electron microscopy according to Example 1.

FIG. 2 illustrates a PEKK suspension in transmission electron microscopy with negative coloration according to Example 3.

FIG. 3 illustrates a scanning electron microscopy view of the film formed from a PEI suspension according to Example 7.

FIG. 4 illustrates a scanning electron microscopy view of a cryofracture of the PEEK/carbon fiber composite sized with a suspension of PEI according to Example 7.

### EXAMPLES

### Example 1

Dissolve 0.0922 g of polyetherimide (n=20) (PEI) in 2 mL of chloroform.

In a beaker containing 0.1005 g of sodium dodecylsulfate (SDS) solubilized in 20 mL of distilled water, pour the PEI solution dissolved in chloroform.

Place the beaker in a water bath at room temperature and emulsify with ultrasound, continuous power 4 for 5 minutes (Vibra Cell, Bioblock Scientific, 600 W, 20 kHz).

Totally evaporate the chloroform under magnetic stirring at 1,000 revolutions per minute at room temperature and under atmospheric pressure.

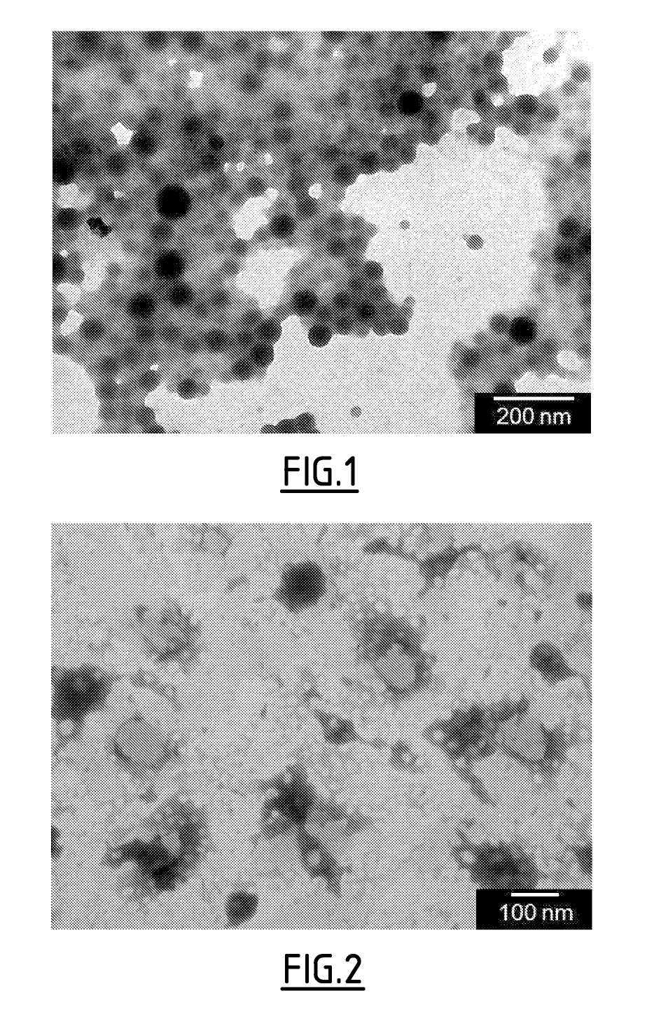

The suspended PEI particles are of a homogeneous size of the order of 65 nm with a polydispersity index of 0.33 (FIG. 1).

The obtained aqueous suspension is stable for 6 months at room temperature.

### Example 2

Dissolve 0.0922 g of polyetherimide (n=20) (PEI) in 2 mL of chloroform.

In a beaker containing 0.1005 g of sodium dioctylsulfosuccinate (SDOS) dissolved in 20 mL of distilled water, pour the solution of PEI dissolved in chloroform.

Place the beaker in a water bath at room temperature and emulsify with ultrasound, continuous power 4 for 5 minutes (Vibra Cell, Bioblock Scientific, 600 W, 20 kHz).

Totally evaporate the chloroform with magnetic stirring at 1,000 revolutions per minute at room temperature and at atmospheric pressure.

The suspended PEI particles are of a homogeneous size of the order of 50 nm with a polydispersity index of 0.29.

The obtained aqueous suspension is stable for six months at room temperature.

### Example 3

Homogeneously disperse 0.0922 g of polyetherketoneketone (n=3) (PEKK) as described in the literature (Y. Sakaguchi et al., SEN'I GAKKAISHI, Vol. 62, No. 7 (2006), p. 141; M. G. Zolotukhin et al., Polymer, Vol. 38, No 6 (1997), p. 1471), in 2 mL of chloroform by using an ultrasound bath.

In a beaker containing 0.1005 g of sodium dodecylsulfate (SDS) dissolved in 20 mL of distilled water, pour the PEKK dispersion prepared in chloroform.

Place the beaker in a water bath at room temperature and emulsify/disperse with ultrasound, continuous power 4 for 5 minutes (Vibra Cell, Bioblock Scientific, 600 W, 20 kHz).

Totally evaporate the chloroform with magnetic stirring at 1,000 revolutions per minute at room temperature and at atmospheric pressure.

The suspended PEKK particles are of a homogeneous size of the order of 100 nm with a polydispersity index of 0.28. Electron microscopy (FIG. 2) also shows small particle aggregates of 35 nm.

The obtained aqueous suspension is stable for six months at room temperature.

### Example 4

Thoroughly disperse 0.0922 g of polyetherketoneketone (n=3) (PEKK) as described in the literature (Y. Sakaguchi et al., SEN'I GAKKAISHI, Vol. 62, No. 7 (2006), p. 141; M. G. Zolotukhin et al., Polymer, Vol. 38, No 6 (1997), p. 1471) in 2 mL of chloroform by using an ultrasound bath.

In a beaker containing 0.1005 g of sodium dioctylsulfosuccinate (SDOS) dissolved in 20 mL of distilled water, pour the PEKK dispersion prepared in chloroform.

Place the beaker in a water bath at room temperature and emulsify/disperse with ultrasound, continuous power 4 for 5 minutes (Vibra Cell, Bioblock Scientific, 600 W, 20 kHz).

Totally evaporate the chloroform with magnetic stirring at 1,000 revolutions per minute at room temperature and at atmospheric pressure.

The suspended PEKK particles are of a homogeneous size of the order of 150 nm with a polydispersity index of 0.46.

The obtained aqueous suspension is stable for 6 months.

### Example 5

### Method P2

Thoroughly dissolve 0.0922 g of polyetherimide (n=20) (PEI) in 2 mL of N-methyl-2-pyrrolidone (NMP).

In a beaker containing 0.1005 g of sodium dodecylsulfate (SDS) dissolved in 20 mL of distilled water, pour dropwise and with ultrasound the solution of PEI dissolved in NMP by means of a glass syringe.

Continue stirring with ultrasound for 10 minutes in order to obtain an opalescent solution.

Control the temperature by means of a cold water bath for the whole duration of the stirring.

The suspended PEI particles are of a homogeneous size of the order of 170 nm with polydispersity index of 0.55.

The obtained aqueous suspension is stable for six months.

### Example 6

### Method P2

Thoroughly dissolve 0.0922 g of polyetherimide (n=20) (PEI) in 2 mL of N-methyl-2-pyrrolidone (NMP).

In a beaker containing 0.1005 g of sodium dodecylsulfate (SDOS) dissolved in 20 mL of distilled water, pour dropwise and with ultrasound the solution of PEI dissolved in NMP by means of a glass syringe.

Continue the stirring with ultrasound for 10 minutes in order to obtain an opalescent solution.

Control the temperature by means of a cold water bath during the whole duration of the stirring.

The suspended PEI particles are of a homogeneous size of the order of 130 nm with a polydispersity index of 0.45.

The obtained aqueous suspension is stable for 6 months.

### Example 7

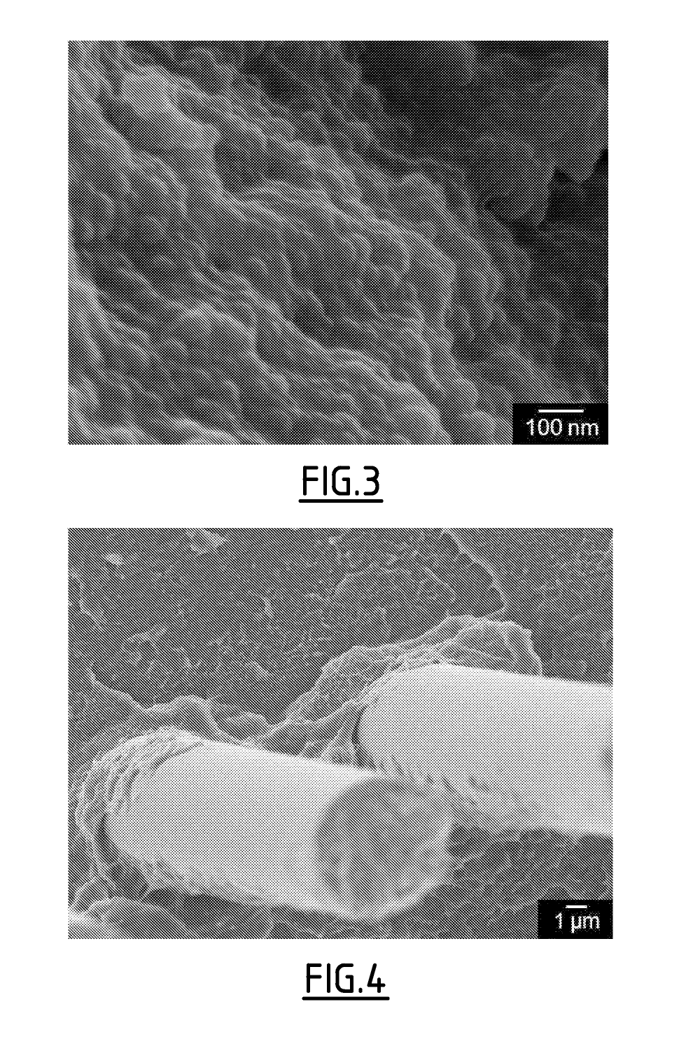

The sizing obtained according to example 1 is sprayed on a non-sized rove of carbon fibers of the type AS4 12000 filaments (Hexcell, USA), which after evaporation leads to a homogeneous PEI film (FIG. 3). Once the rove is sized, it is inserted between two films of 100 μm of polyetheretherketone (PEEK) and the whole is placed in a mold coated beforehand with a mold-removal agent, between two 400° C. heating plates put into contact for 15 minutes. As soon as the mold attains a temperature of 100° C., the composite may be removed from the mold. As shown by the SEM image of a cryofracture (FIG. 4), the sizing properly wraps up the fiber and is also mingled with the matrix.

The same procedure was used for sizing carbon fibers with the aqueous dispersions obtained according to Examples 2 to 6.

1. An aqueous stable dispersion of nanoparticles of a high performance thermoplastic polymer or of mixtures of high performance thermoplastic polymers.

2. The dispersion according to claim 1, such that said polymer(s) is(are) selected from polyetherimides, polyaryletherketones and mixtures thereof.

3. The dispersion according to claim 1, such that said nanoparticles have an average diameter comprised between 10 and 1,000 nm.

4. The dispersion according to claim 1 such that the mass percentage of said polymers is comprised between 0.01 and 0.1%.

5. The dispersion according to claim 1, further comprising one or more emulsifying and/or dispersing agents selected from the family of surfactants or water-soluble or amphiphilic polymers.

6. The dispersion according to claim 5, such that the mass percentage of emulsifying and/or dispersant agent is comprised between 0.01 and 20%.

7. A method for preparing a dispersion according to claim 1, comprising the transfer of said polymer(s) of a solution or dispersion in an organic solvent or in a mixture of organic solvents to an aqueous phase, such that:
said polymer(s) is(are) soluble or dispersible in said organic solvent(s); and
said organic solvent(s) is(are) miscible with water.

8. The method according to claim 7, such that said method comprises the evaporation step from an emulsion of said polymer(s) soluble in said volatile organic solvent(s) non-miscible with water.

9. The method according to claim 7, such that said method comprises the evaporation step from an oil-in-water emulsion/dispersion of said polymers dispersible in said volatile organic solvent(s) and non-miscible with water.

10. The method according to claim 7, such that said method comprises the diffusion step for a solution of said polymer(s) in said organic solvent(s) miscible with water.

11. The method according to claim 7, said method comprises the step for diffusing a dispersion of said polymer(s) in said organic solvent(s) miscible with water.

12. The method according to claim 8 such that said volatile organic solvent(s) non-miscible with water are selected from chloroform, methylene chloride, dichloromethane, dichloroethane, aliphatic hydrocarbons, halogenated aliphatic hydrocarbons, aromatic hydrocarbons, cyclohexane, halogenated aromatic hydrocarbons, ethers, ethyl acetate, ethyl formate and mixtures thereof.

13. The method according to claim 10, said organic solvent(s) miscible with water are selected from methanol, ethanol, isopropanol, dimethylformamide, dimethylsulfoxide, acetonitrile, acetone, dioxane and N-methyl-2-pyrrolidone.

14. The method according to claim 7, such that the mass percentage of polymer(s) in said organic solvent(s) is comprised between 0.1 and 10%.

15. The method according to claim 7, characterized in that it comprises the following steps:
a) dissolution or dispersion of said polymer(s) in said organic solvent(s);
b) mixing of the solution or dispersion obtained in step (a) with the aqueous solution optionally comprising one or more emulsifying and/or dispersant agents;
c) evaporation or diffusion of said organic solvent(s).

16. A method for generating a film on a support comprising:
deposition of a dispersion according to claim 1 on said support; and
evaporation of the water.

17. The method according to claim 16, such that said support is selected from carbon fibers or nanotubes, aramide fibers.

18. Sized fibers which may be obtained by the method according to claim 16.

19. A sizing comprising nanoparticles of a high performance thermoplastic polymer or of high performance thermoplastic polymers according to claim 1.

20. A composite material comprising:
sized fibers according to claim 18 and
a thermoplastic polymer matrix.
